(19) United States
(12) Patent Application Publication
(10) Pub. No.: US 2014/0350979 A1
(43) Pub. Date: Nov. 27, 2014

(54) MULTI-MODAL JOURNEY PLANNING AND PAYMENT

(71) Applicant: CUBIC CORPORATION, San Diego, CA (US)

(72) Inventors: Kay Paetzold, Hamburg (DE); Boris Karsch, Beaconsfield (AU)

(73) Assignee: CUBIC CORPORATION, San Diego, CA (US)

(21) Appl. No.: 14/283,531

(22) Filed: May 21, 2014

Related U.S. Application Data
(60) Provisional application No. 61/825,922, filed on May 21, 2013.

(51) Int. Cl. G06Q 50/14; G06Q 20/14; G06Q 10/02

(52) U.S. Cl. CPC G06Q 50/14; G06Q 10/025; G06Q 20/14
USPC 705/6

(57) ABSTRACT

Techniques are disclosed for providing trip planning and associated payment of a trip involving multiple modes of transportation (i.e., “multi-modal trip planning”). Embodiments can enable a user to plan a multi-modal journey on an electronic device, and pay for products (tolls, tickets, etc.) associated with the journey on the same electronic device, or a different electronic device. Embodiments can also allow for re-planning a journey, providing for an alternative route when current information regarding an original route suggests the alternate route would be advisable. Payment for products associated with the alternate route can be provided.

### CROSS-REFERENCE TO RELATED APPLICATION

The present application claims benefit under 35 USC 119(e) of 61/825,922, filed May 21, 2013, entitled “MULTI-MODAL JOURNEY PLANNING AND PAYMENT WITH CAR CONSOLE INTEGRATION,” the entire contents of which are incorporated by reference herein for all purposes.

### BACKGROUND

The options available for individuals (“travelers”) to plan travel, pay for travel, and receive information about their journey are changing rapidly as new technologies become available, such as mobile phone technology, high-speed mobile data services, and in-vehicle computers. At the individual level, travelers increasingly have access to personal portable computing devices (“PPCDs”) connected to mobile data networks, such as smartphones, tablet computers, portable media devices, and the like.

Motor vehicles are increasingly equipped with on-board computers (“onboard units”) that provide drivers and passengers with access to information and transactional services including navigation, business directories, media playing, and the like. Onboard units are either built into the motor vehicle or purchased as stand-alone units after market. Onboard units can come with a range of communication options allowing the units to receive and send information. Communication interfaces can include radio, satellite, in-build mobile network connection and the ability to tether the onboard unit to a stand-alone communication interface (such as a mobile phone).

Today's travel journeys often utilize multiple modes of transport as travelers go from point A to point B. For example, a complete journey may start-out in a personal motor vehicle, involve parking at a train station, use of a train to get to downtown, a further leg on a downtown subway system, and may further utilize a taxi services, bikeshare rental or carshare rental for the last leg of travel. Planning and paying for such complex journeys currently requires travelers to interact with multiple planning tools (such as websites and mobile applications) and use multiple forms of payments.

### BRIEF SUMMARY

Techniques are disclosed herein for providing trip planning and associated payment of a trip involving multiple modes of transportation (i.e., “multi-modal trip planning”). Embodiments can enable a user to plan a multi-modal journey on an electronic device, and pay for products (tolls, tickets, etc.) associated with the journey on the same electronic device, or a different electronic device. Embodiments can also allow for re-planning a journey, providing for an alternative route when current information regarding an original route suggests the alternate route would be advisable. Payment for products associated with the alternate route can be provided.

An example computer-implemented method of providing trip planning using multiple modes of transportation, according to the disclosure, includes obtaining, subsequent to a determination of a first route of travel, information regarding the first route of travel. The first route of travel comprises a first set of travel instructions to a destination provided to a first user device. The method further includes determining, using the obtained information regarding the first route of travel, that travel along the first route of travel could be impacted, and determining, with a processing unit and based on the obtained information regarding the first route of travel, a second route of travel. The second route of travel comprises a second set of travel instructions to the destination, different than the first set of travel instructions, and the second route of travel involves multiple modes of transportation. The method also includes providing, via a communication interface, the second route of travel, and receiving, via the communication interface, information for a payment associated with at least one of the multiple modes of transportation of the second route of travel.

The example computer-implemented method of providing trip planning using multiple modes of transportation can also include one or more of the following features. The information for the payment can include a payment authorization, and the method can further include storing an account associated with a user, and changing a value of the account to reflect the payment. The method can include receiving, from the first user device, information regarding delivery of one or more products associated with the multiple modes of transportation. The method can include providing, to a second user device, information for using at least one of the one or more products. The delivery of the one or more products can include at least one of displaying of a barcode, printing of a paper ticket, or changing a value of a user account. Determining the second route of travel can be further based on information regarding an environmental impact of the multiple modes of transportation. Providing the second route of travel can include providing the second route of travel to at least one of the first user device or a second user device. Receiving the information for the payment can include receiving the information for the payment from at least one of the first user device or a second user device.

An example computing device for providing trip planning using multiple modes of transportation, according to the disclosure, can include a memory, a communication interface, and a processing unit communicatively coupled with the memory and the communication interface. The processing unit can be configured to cause the computing device to obtain, subsequent to a determination of a first route of travel, information regarding the first route of travel, where the first route of travel includes a first set of travel instructions to a destination provided to a first user device. The processing unit also can be configured to cause the computing device to determine, using the obtained information regarding the first route of travel, that travel along the first route of travel could be impacted, and determine, with the processing unit and based on the obtained information regarding the first route of travel, a second route of travel, where the second route of travel includes a second set of travel instructions to the destination different than the first set of travel instructions, and the second route of travel involves multiple modes of transportation. The processing unit also can be configured to cause the computing device to provide, via the communication interface, the second route of travel, and receive, via the communication interface, information for a payment associated with at least one of the multiple modes of transportation of the second route of travel.

The processing unit can be further configured to cause the computing device to implement one or more of the following features. Store an account associated with a user, and change a value of the account to reflect the payment. Receive, from the first user device, information regarding delivery of one or more products associated with the multiple modes of transportation. Determine the second route of travel based on information regarding an environmental impact of the multiple modes of transportation. Provide the second route of travel by providing the second route of travel to at least one of the first user device or a second user device. Receive the information for the payment from at least one of the first user device or a second user device.

An example non-transitory computer-readable medium, according to the disclosure, can have instructions embedded thereon for providing trip planning using multiple modes of transportation. The instructions can include computer code for causing a computing device to receive information indicative of a first route of travel, the first route of travel comprising a first set of travel instructions to a destination, and receive, while the computing device is traveling along the first route of travel, information regarding a second route of travel. The second route of travel can include a second set of travel instructions to the destination, different than the first set of travel instructions, and the second route of travel can involve multiple modes of transportation. The instructions can further include computer code for causing a computing device to receive user input regarding a payment associated with at least one of the multiple modes of transportation of the second route of travel, and communicate, via a communication interface of the computing device and in response to receiving the user input, information regarding the payment associated with at least one of the multiple modes of transportation of the second route of travel.

The example computer-readable medium can further include instructions for causing the computing device to perform one or more of the following functions. Receive, prior to receiving the user input, an indication that a user is in a safe environment to provide the user input. (The indication that a user is in a safe environment may include an indication that the user has stopped moving.) Receive an audio command as the user input. Receive user input regarding a selection of the second route of travel. Communicate information indicative of the selection of the second route of travel.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of a system for enabling multi-modal trip planning, according to one embodiment.

FIG. 2 is a flow diagram illustrating a process for providing multi-modal planning, according to one embodiment.

FIG. 3 is a flow diagram illustrating a process of re-planning a route based on travel condition information, according to one embodiment.

FIG. 4 is a flow diagram illustrating a computer-implemented method for providing trip planning using multiple modes of transportation, according to one embodiment.

FIG. 5 is a block diagram of an example computing system.

### DETAILED DESCRIPTION

For the purposes of explanation, the ensuing numerous provides specific details are set forth in order to provide a thorough understanding of various embodiments. It will be apparent, however, to one skilled in the art that various embodiments may be practiced without some of these specific details. For example, circuits, systems, networks, processes, and other components may be shown as components in block diagram form in order not to obscure the embodiments in unnecessary detail. In other instances, known circuits, processes, algorithms, structures, and techniques may be shown without unnecessary detail in order to avoid obscuring the embodiments. In other instances, well-known structures and devices are shown in block diagram form.

Techniques provided herein are directed toward utilizing planning and paying for travel to a destination in which multiple modes of transportation can be utilized. A personal portable computing devices (“PPCD”) and/or on-board computers (“onboard units”) of a motor vehicle may be utilized to provide information and/or products to a traveler.

As used herein, the terms “trip” and “journey” generally refer to a plan to go to a particular destination. The term “route” generally refers to the particular means and/or method of getting to the particular destination. Thus, a trip or journey could include one or more routes (e.g., a primary route and one or more alternative routes) for arriving at a destination.

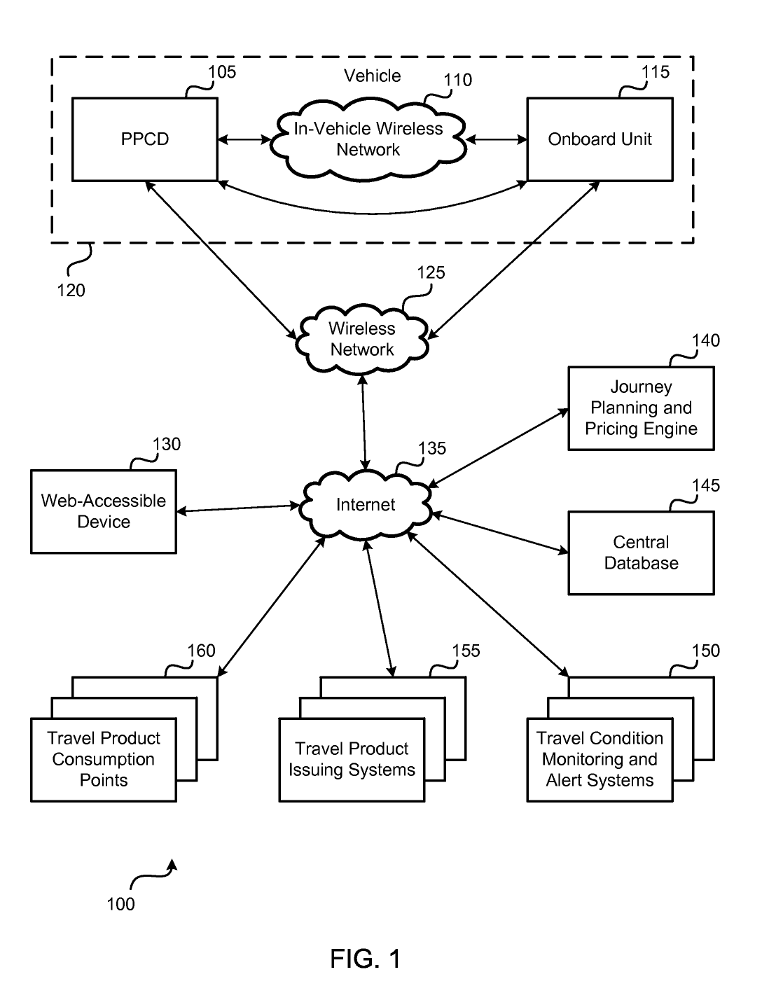

FIG. 1 is a block diagram of a system 100 for enabling multi-modal trip planning, according to one embodiment. Among other things, and as discussed in further detail below, the system 100 can provide for a variety of functions related to multi-modal trip planning, including but not limited to initial journey planning, initial journey payment, travel product delivery, receiving route condition information (e.g., en route), re-planning (e.g., en route) to allow a traveler to deal with an interruption, and/or registration of various items (e.g., a car, license plate, PPCD, transit fare product, and the like) to link the items to a payment account. Although examples herein describe multi-modal planning, the system 100 can additionally or alternatively provide single-modal trip planning (i.e., the planning of a trip involving a single mode of transportation). Other embodiments may combine, separate, add, omit, and/or rearrange components, and/or include other alterations to the embodiment illustrated in FIG. 1. Furthermore, components may be executed in hardware and/or software of one or more computing devices (e.g., computer servers, personal computers, personal electronic devices, specialized computing devices, and the like), which may be geographically distributed and/or localized, depending on desired functionality. Furthermore, although the PPCD 105 is indicated as being in the vehicle 120 in FIG. 1, applications further contemplate the PPCD 105 being at any of a variety of other locations that may be outside the vehicle 120.

The components illustrated in FIG. 1 can provide various different functions depending on desired functionality of the system 100 and the way in which the system 100 is utilized by travelers. In general, one or more travelers can plan a trip using an electronic device such as a PPCD 105 (e.g., a tablet, smart phone, personal media player, etc.), a web-accessible device 130 (e.g., a laptop, personal computer, web-connected television, etc.), or an onboard unit 115 of a vehicle 120. Such an electronic device can utilize a software application, web page, or other feature to communication information to a journey planning and pricing engine 140, which can utilize a wide variety of information to determine one or more available routes for a trip. Because many routes to a particular destination of the trip may exist, the journey planning and pricing engine 140 can select a particular route to use or allow a traveler to select (e.g., via the electronic device) a desired route from a list of alternate routes. Route information can include a map, driving instructions, ticket information, walking instructions, parking information, estimated travel time (total and/or for portions of a route), and/or other information associated with travel along a route, and may be utilized by the electronic device en route (e.g., displaying a map, providing directions and/or instructions, and the like). Furthermore, the journey planning and pricing engine 140 can determine a price associated with each route (e.g., from parking, tolls, transit, taxi, etc.), if any, and provide that to the traveler along with the route information.

The journey planning and pricing engine 140 may utilize payment rules to calculate the actual cost of a journey based on input parameters including the journey to be taken, time-of-day of travel, concession status of the traveler, and the like. The journey planning and pricing engine 140 can also be used to configure multi-modal pricing rules such as discounts or packaged prices available for combinations of transportation modes (e.g., combined park and ride tickets). Because routes can involve one or modes of transportation, the journey planning and pricing engine 140 can store and/or remotely access information regarding a wide variety of transportation modes to determine available routes for a selected trip. Such information can include pricing, ticketing, routes, schedules, and/or other information related to available transportation systems. Transportation systems can include, for example, subway, light rail, commuter rail, bus, rental car, taxi, car and/or bicycle sharing networks, airports, and the like. The journey planning and pricing engine 140 may further store and/or remotely access other information regarding a route, such as information regarding tolls, parking, and the like. Moreover, the store and/or remotely access travel condition information from one or more travel condition monitoring and alert systems 150, which can indicate current conditions that could affect travel, such as traffic congestion and accidents, transit delays, and the like. The journey planning and pricing engine 140 can factor in such information, in addition or as an alternate to the information above, when determining routes of travel.

The journey planning and pricing engine 140 may additionally consider user preferences, which can be stored by a central database 145. User preferences may be linked to a particular traveler and stored in an associated user account. User preferences may include, for example, information regarding a traveler's preferences toward taking a fastest route, a shortest route, a most environmentally-friendly route, a most cost-effective route, and the like. This information can impact how the journey planning and pricing engine 140 determines available routes and/or routes to provide to a traveler for selection.

For example a traveler may include a preference regarding indirect costs of the journey, such as environmental impact through CO₂ emission or other pollution metrics. This can be factored in to journey planning by adding environmental impact models (such as CO₂ emissions) to the journey planning and pricing engine 140 that calculates CO₂ impact of the journey. In a public transit scenario, the journey planning and pricing engine 140 can utilize analytical models combining vehicle information, information from vehicle management systems (such as a bus engine management system), traffic information and information from the transport mode operator on energy consumption and sources (for example, a percentage of energy sourced by an agency from various energy sources such as coal power, hydro power, and/or other sources) to deliver accurate environmental impact metrics.

A traveler may additionally or alternatively have preferences regarding time and/or cost. For instance, a traveler may specify a balance of preference of time to travel and direct and indirect cost preferences. Additionally or alternatively, a traveler may indicate a variability in journey time that he or she is willing to accept (that is, how important it is to the traveler to arrive on time). To implement such functionality, the journey planning and pricing engine 140 may be integrated with both traffic data (for road travel) and public transport data (e.g., performance and/or historic arrival data) to establish measures of variability using analytics methods on this data.

Another example traveler preference may indicate route exclusions such as locations or routes that the traveler prefers not take. Perceived unsafe parts of town or transit stations, for instance, may be indicated as places to avoid. Likewise, a traveler may specify routes and/or transportation modes that the traveler prefers. Such functionality can be implemented, for example, by equipping the journey planning and pricing engine 140 with system learning algorithms to adapt when a traveler consistently selects one route option over another. Additionally or alternatively, a graphical user interface (GUI) may enable a traveler to specify route preferences, and a route preference profile with these preferences can be stored at a local device (e.g., PPCD 105) and/or remotely by the central database 145.

Once a route is selected (e.g., by the journey planning and pricing engine 140 or by a traveler selecting from a list of available routes via the electronic device), one or more travel product issuing systems 155 (and/or other component(s) of the system 100) can allow the traveler to purchase products associated with the selected route, such as transit tickets, parking passes, and the like. Such purchases can be made using, for example, a value associated with the traveler's user account (which may be stored on the central database 145), a payment card (credit, debit, etc.), a transit card and/or account, and the like.

Furthermore, the products may be delivered in any of a variety of ways, which may be selectable by the traveler. For example, products may be delivered to travel product consumption points 160, such as toll roads, parking gates, public transport ticketing devices, and the like. Additionally or alternatively, products may be delivered to a web-accessible device 130 (enabling, for example, a personal computer to print a paper ticket with a connected printer), a PPCD 105 (enabling, for example, the PPCD 105 to display a bar code and/or wirelessly transmit a ticket in electronic form), or other device.

Usage of a journey planning and pricing engine 140 and/or central database 145 can further facilitate the use of multiple devices for multi-modal trip planning by storing information in the “cloud.” That is, a traveler may be able to plan a journey on a first device and later use a second device to facilitate travel along a second route. For example, a traveler may use a web-accessible device 130 to select a desired route for a journey. The selected route and associated journey plans can then be stored in the cloud (e.g., by the journey planning and pricing engine 140, central database 145, and/or other component(s) of the system) for access by the onboard unit 115 or PPCD 105. Additionally or alternatively, the selected route and/or associated journey plans can be stored encoded in an electronic format that can be sent, via email, SMS or other message mechanism, to the onboard unit 115 or PPCD 105.

Communication between components of the system 100 can vary, depending on desired functionality. As shown, various components can communicatively interact via the Internet 135 and/or other communication networks. The PPCD 105 and/or onboard unit 115 can connect with the Internet 135 via a wireless network 125 (e.g., a mobile wireless carrier network, satellite network, etc.), and they may communicate with each other via an in-vehicle wireless network 110, which can include a variety of wireless technologies such as Wi-Fi, Bluetooth™, near-field communication (NFC), optical, and the like. Additionally or alternatively, the onboard unit 115 may communicate with the PPCD by providing a bar code and/or other visual feature, which can be scanned with a camera of the PPCD 105.

As previously indicated, the components illustrated in FIG. 1 can provide various different functions, depending on desired functionality of the system 100 and the way in which the system 100 is utilized by travelers. Such various functions are further illustrated in the flow diagrams of the following figures.

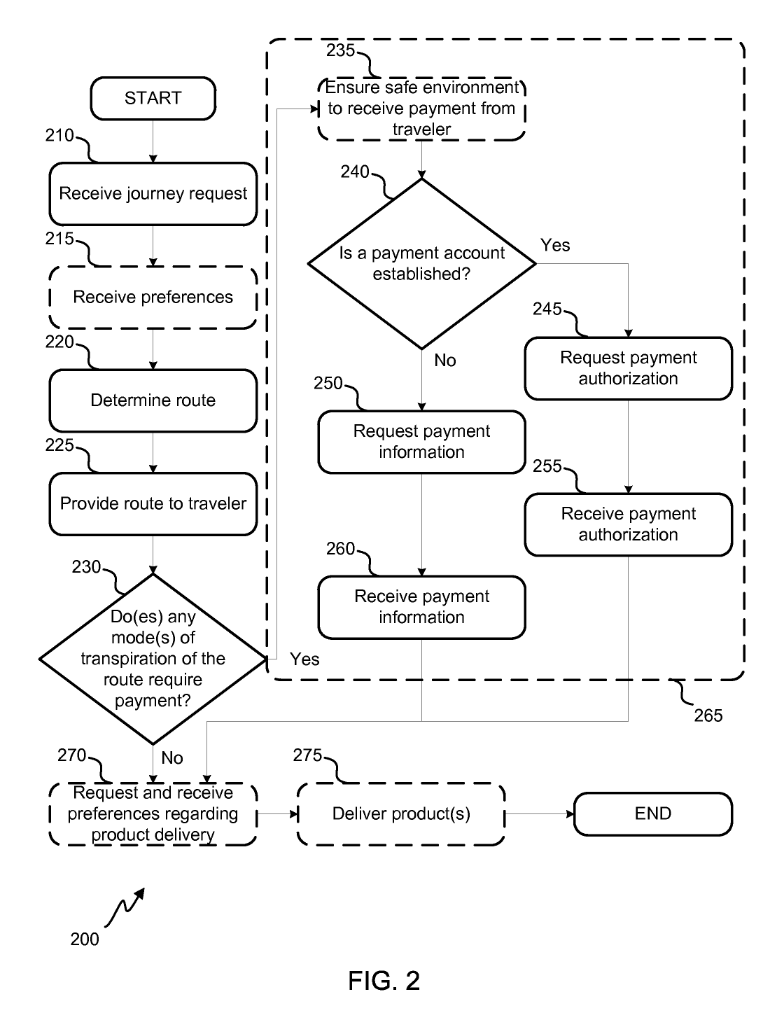

FIG. 2 is a flow diagram 200 illustrating a process for providing multi-modal planning, according to one embodiment. The process shown in the flow diagram 200 can be executed, for example, by one or more components of the system 100 of FIG. 1. Alternatively, they may be executed by one or more systems other than the system 100 of FIG. 1. As with other figures herein, components may be altered (e.g., added, omitted, rearranged, combined, separated, etc.) in alternative embodiments, depending on desired functionality.

At block 210 a journey request is received. The request can be generated, for example, at a web-accessible device 130, PPCD 105, onboard unit 115, or other electronic device, via a journey planning tool such as an application or website, as previously indicated. The request can include journey parameters such as a destination, preferences, and the like, and it can be sent to the journey planning and pricing engine 140. Optionally, at block 215, the preferences of a traveler may be additionally or alternatively received from, for example, a user account for the traveler stored at a central database 145.

At block 220 a route for the requested journey is determined. As previously indicated, the route can be determined, for example, by the journey planning and pricing engine 140. In some embodiments determining the route can include providing a list of available routes back to the traveler (via, for example, the web-accessible device 130) allowing the traveler to select a route to take. In either case, at block 225, the route is provided to the traveler.

At block 230 it is determined whether one or more modes of transportation require (or allow) payment. That is, a selected route may include one or more modes of transportation in which payment can be made. If not, the process may optionally move to blocks 270 and 275, in which a preferences regarding product delivery are requested and received, and one or more corresponding products are delivered, respectively. Additional detail regarding the functionality associated with these blocks is provided below (describing instances when payment is made). However, in some instances, a product (e.g., a reservation) associated with the chosen route may not allow for payment, but may nonetheless be delivered. That said, for selected routes in which no products are to be delivered, the functionality at blocks 270 and 275 can be omitted.

Where one or more products associated with the chosen route may allow for payment (or “prepayment”), the process can advance to a series of blocks 265 for conducting a payment transaction. This allows the traveler to pre-purchase travel products associated with the selected route (e.g., toll pass, parking permit, public transport ticket, etc.).

Optionally, at block 235, a safe environment may be ensured to receive payment from a traveler. For example, because payment can be made using a PPCD 105 or onboard unit 115 while a traveler is in a vehicle 120, it may be a danger to the traveler and others if the traveler is driving the vehicle 120 while attempting to conduct a payment transaction on the PPCD 105 or onboard unit 115. In such cases, the PPCD 105 or onboard unit 115 may postpone taking any further steps in the payment transaction until the vehicle 120 has come to a stop (indicated, for example, by a GPS receiver, motion sensor, etc. of the PPCD 105 or onboard unit 115) and/or the traveler has confirmed that the vehicle has stopped, or until the traveler has confirmed that he or she is not driving the vehicle 120. Additionally or alternatively, the payment transaction may be conducted if it is determined that conducting the payment transaction may be done without distracting a traveler who is driving a vehicle 120. This can be done, for example, using one or more simple audible prompts and commands in a manner that allows a traveler to maintain focus on the road while driving. Such functionality can be enabled and/or facilitated in cases in which the traveler's payment information is previously provided (e.g., stored on the PPCD 105 or onboard unit 115, stored in an account on the central database 145 or other component, etc.)

At block 240, it is determined whether a payment account is established for the traveler. A payment account can include, for example, an account having value with which one or more products associated with a selected route may be purchased. The payment account can include, for example, a prepaid account and/or credit account, or may simply link the traveler to a credit, debit, or other payment card or account. To help ensure a traveler's payment account is secure, the journey planning tool may ask the traveler to provide one or more credentials (e.g., a username, password, etc.) before making a payment and/or planning the journey.

A payment account can be established in a variety of ways, according to desired functionality. It can simply be done, for example, by allowing a traveler to select a payment provider and giving credentials or registering new ones. In either case, this can result in a token that is valid for a vehicle 120. The token can then be then passed as reference in a payment-by-reference transaction. The token can contain an expiration data and may or may not just valid together with a short PIN.

If a payment account is already established, payment authorization can be requested at block 245 and received at block 255. Such payment authorization can include receiving one or more credentials from the traveler (as previously indicated), or a simple confirmation to pay for the product(s) using a value (e.g., monetary value) associated with the payment account.

Alternatively, if a payment account is not already established, the process may include requesting payment information from the traveler at block 250, and receiving the payment information at block 260. Payment information can include information such as a credit, debit, or other payment card number, and/or other information for providing payment for the product(s) without an account designated for such payments. In the example system 100 of FIG. 1, depending on the method of payment, payment information can be sent to one or more components of the system 100 configured to process such payments, such as travel product issuing systems 155, the journey planning and pricing engine 140, and/or other component.

Optionally, at block 270, preferences regarding product delivery can be requested and received. In other words, embodiments may enable a traveler to specify where the electronic travel products are to be delivered. For example, where the travel product is manifest in a product or value stored in an account, the account can be updated to reflect the purchase. For instance, a toll day-pass can be delivered to a toll account linked to the vehicle in which the traveler is travelling. Where the travel product is a ticket, such as a barcode technology public transport ticket, the ticket can be delivered to the PPCD 105 of the traveler. Additionally or alternatively, a product can be delivered as an auto load directive to a transit gate or as virtual instrument delivered to an open loop account. Where available, products may also be delivered to a secure element of a PPCD 105. In case of a tolling or parking service, the product (e.g., a ticket or entitlement) may delivered to the cloud, taking, for example, the license plate as identification. At block 275, the one or more products are delivered accordingly.

As stated previously, the functionality of the process illustrated in FIG. 2 can be altered, depending on desired functionality of the system and/or factors associated to specific travel scenarios. For example, the process of FIG. 2 may accommodate multiple travelers (e.g., multiple passengers in a vehicle 120) by enabling the purchase of one or more products associated with the selected route for each traveler, conducting separate payment transactions for separate travelers, and/or delivering products to each traveler (e.g., to the PPCD 105 of each traveler). A person of ordinary skill in the art will recognize many additional variations to the embodiment illustrated in FIG. 2.

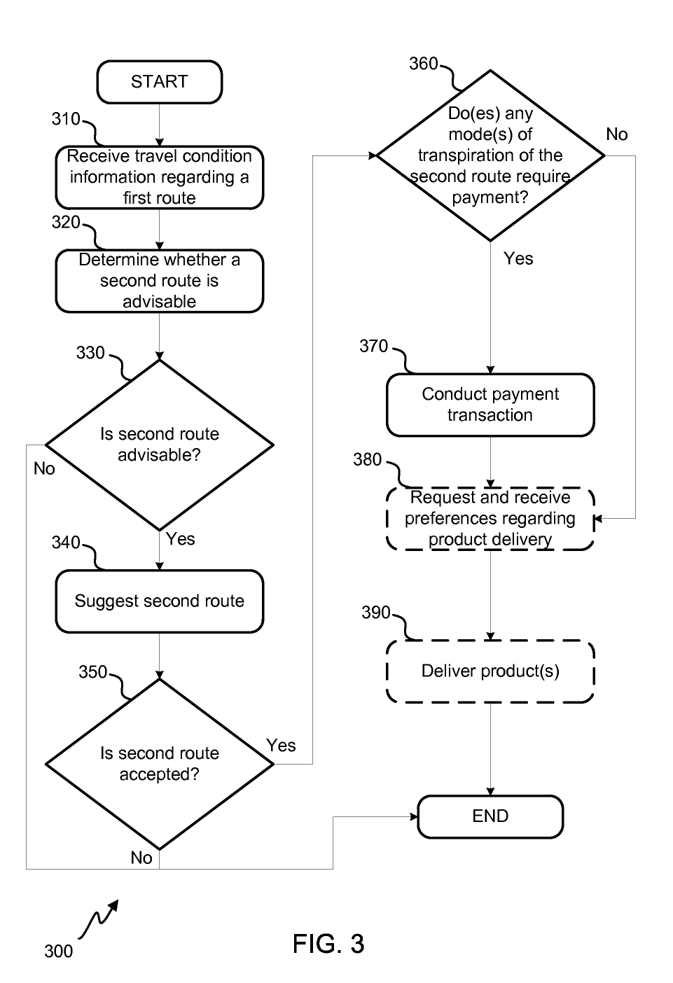

FIG. 3 is a flow diagram 300 illustrating a process of re-planning a route based on travel condition information, according to one embodiment. Such functionality can, for example, notify one or more travelers of one or more events that may impact travel on a first route and allow the one or more travelers to select an alternate route while traveling on a first route. The process can be initiated periodically during travel to help determine whether an alternate route is advisable given current travel conditions associated with a first route.

At block 310, travel condition information regarding a first route can be received. Travel condition information can vary depending on desired functionality, mode(s) of transportation, and/or other factors. As previously indicated, travel condition information can be provided by various systems (e.g., the travel condition monitoring and alert systems 150 of FIG. 1), and may include vehicle traffic and/or other travel congestion information, transit alerts and/or delays, information regarding accidents and/or other emergencies along a travel route, updated information regarding parking availability, and/or other information pertinent to travel along a selected route.

At block 320, it is determined whether a second (alternative) route is advisable. Such a determination can be made by determining alternative routes using the techniques, systems, and factors previously discussed for route determination, and determining whether a second route, from one or more identified alternative routes, is preferable over the first route (e.g., in light of any user preferences).

The answer to this determination is considered at block 330. If the determination is that the second route is not advisable, the process can simply end at that point. However, if the determination is that the second route is advisable, the process can proceed to block 340, at which the second route is suggested to the traveler. In the system 100 of FIG. 1, for example, the journey planning and pricing engine 140, the PPCD 105, and/or the onboard unit 115 may make the determination that the second route is advisable, and the second route (and possibly other alternative routes) may be suggested to a traveler (e.g., via a display of the PPCD 105 or onboard unit 115).

At block 350, it is determined whether the second route has been accepted by a traveler. If it has not, then the process can simply end. However, if the second route has been accepted, the process can then include a series of steps (blocks 360, 370, 380, and 390) for product payment and delivery similar to corresponding steps shown in the process of FIG. 2, where conducting the payment transaction of block 370 can include one or more of the payment transaction steps 265 of FIG. 2.

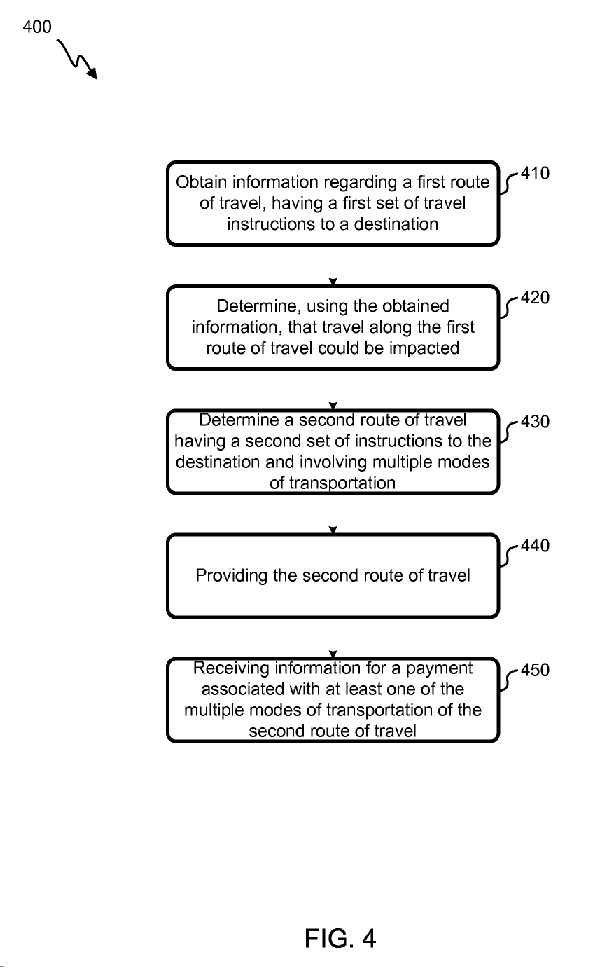

FIG. 4 is a flow diagram illustrating a computer-implemented method 400 for providing trip planning using multiple modes of transportation, according to one embodiment. More particularly, the method includes re-planning of a route of travel given current travel conditions. The method 400 of FIG. 4 can be viewed as implementing particular features of the processes discussed in FIG. 3. Moreover, the method 400 can be executed may a single device. For example, the journey planning and pricing engine 140 of FIG. 1 may execute all components of the method 400. Additionally or alternatively, multiple devices may implement the method 400.

At block 410, information regarding a first route of travel is obtained where the first route of travel has a first set of travel instructions to a destination. As previously indicated, a route can include instructions such as a map, transit information, schedule information, and the like. Additional information can include step-by-step instructions for travel along the route. Such travel instructions may be provided to a first device such as an onboard unit of a vehicle, a PPCD, and the like.

At block 420, the obtained information is then used to determine that travel along the first route of travel could be impacted. For example, current information regarding a condition of the first route of travel (e.g., traffic accidents or congestion, transit delays, etc.) may be obtained and utilized to determine whether there is a possibility that travel along the first route of travel could be impacted.

At block 430, a second route of travel having a second set of instructions to the destination and involving multiple modes of transportation is determined. As indicated with regard to FIG. 3, determining a second route of travel can include processes and considerations similar to those used in the determination of the first (initial) route. Moreover, determining a second route of travel can occur while a traveler is traveling along the first route of travel.

At block 440, the second route of travel is provided. This can comprise, for example, providing the second route of travel to the first device (i.e., the device that received the first route of travel) and/or a second device (different from the first device), to inform the traveler of an advisable alternative route to the first route. The second route of travel may be included in a list of alternative routes to the first route of travel for the traveler to select via the first or second device.

At block 450, information is received for a payment associated with at least one of the multiple modes of transportation of the second route of travel. As indicated previously, payment can be made using an established payment account, a payment card, or other means. Moreover, the information for the payment may be received from a second device (different from the first device that received the first route of travel).

If can be noted that the processes in FIGS. 2-4 and the system 100 of FIG. 1 can facilitate various payment scenarios and schemes. Moreover, different applications (which may be executed by a single device) may be utilized for travel planning and payment of products. For example, an onboard unit 115 can be the user interface via which the traveler authenticates his- or herself to a travel product purchase application running on the onboard unit 115 after selecting an associated route via a journey planning application. The traveler can then complete the purchasing experience using the onboard unit 115 using a variety of techniques.

In a first technique, a journey planning application (e.g., an application enabling a traveler to plan a journey, which may communicate, for example, with a remote journey planning engine) running on the onboard unit 115 conducts an application-to-application transfer to launch a travel product purchasing application that handles traveler authentication. One option to remove the need for a login step and to streamline the user experience is the detection of a registered user (traveler) of a PPCD 105 as being in the vehicle 120. This could include, for example, wirelessly pairing of the PPCD 105 with the onboard unit 115 via radio frequency (RF) signals. (Alternatively the PPCD 105 and onboard unit 115 may both transmit their respective GPS coordinates to a travel product sales portal central system to confirm proximity.) This approach can allow the traveler to login once only once, via the PPCD 105.

In a second technique, the journey planning application running on the onboard unit 115 launches a web browser session on the onboard unit 115. The traveler completes the purchasing process by logging in to a corresponding account and confirming the product(s) to be purchased together with the desired funding source. The interaction with the onboard unit 115 may be via a touch screen, voice command, or other user interface provided by the onboard unit 115.

Alternatively, techniques may enable the onboard unit 115 to allow a PPCD 105 to complete a payment transaction. This approach can reduce the need for complex integration of journey planning applications running on onboard unit 115 with other systems, such as transit ticketing solutions. Moreover, because PPCDs 105 typically have more sophisticated user interfaces than onboard units 115, these techniques can allow for the creation of a more streamlined and easier end-user experience. Such techniques can generally involve a traveler confirming to the onboard unit 115 that he or she wishes to take a selected route and wants to proceed to purchasing applicable products. The traveler can then request that the purchasing be handed-over to a PPCD 105 registered with the onboard unit 115. (The traveler may then select from multiple PPCDs known to the onboard unit 115.) The onboard unit 115 then provides the selected PPCD 105 with information about the intended journey and any related products. The traveler then authenticates him- or herself to the PPCD 105 via existing mechanisms (patterns, passwords, biometrics, etc.) to access the PPCD 105 and a travel product purchase application executed thereon. The traveler can then utilize the travel product purchase application to complete product selection, purchasing, and selection of delivery options.

More broadly, information exchanges between either multiple applications on the onboard unit 115 (such as the journey planning application and travel product purchase application) or information exchanges between applications running on the onboard unit 115 and PPCD 105, can occur in a variety of ways in the processes and systems described herein. For example, a first application can provide information to a central system (e.g., the central database 145 in FIG. 1) to obtain a token to this information that can be provided to a second application. The second application can then use the token to retrieve the required information from the central system. In a second example, the first application can encode the required information into an electronic format understood by a second application and provides the information to the second application via a direct interchange. Communication between first and second applications may include passing of parameters through the application launch mechanism, polling for available information the central server through joined logins by each application, or passing via common message protocols including handover of tokens via SMS or email.

Although embodiments provided herein describe pairing between a PPCD 105 and an onboard unit 115, embodiments are not so limited. For example, in some systems, pairing can be between an onboard unit 115 and a credit card or other payment card.

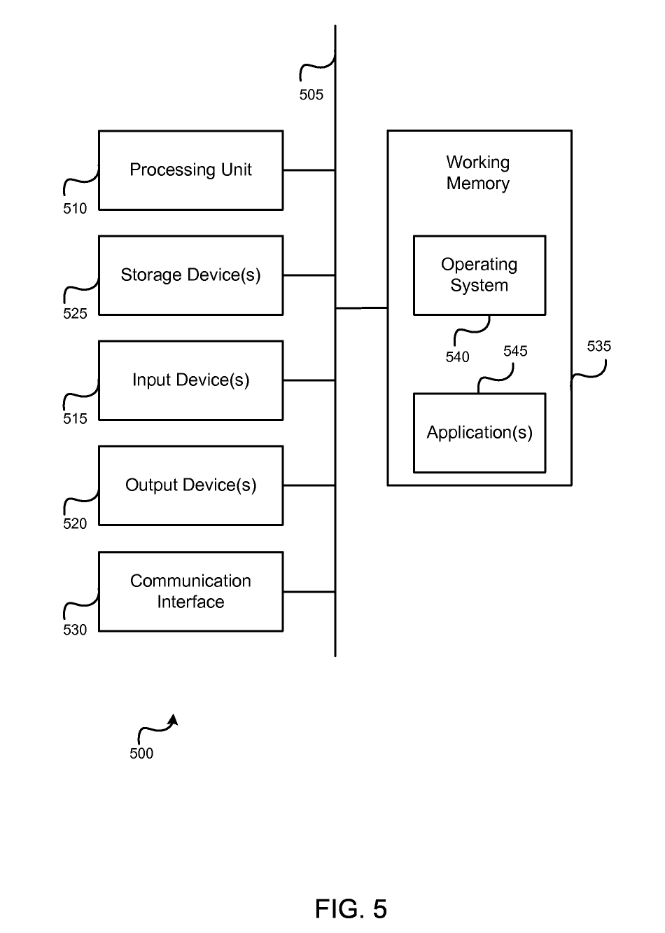

A computer system as illustrated in FIG. 5 may be incorporated as part of the previously described computerized devices. For example, computer system 500 can represent some of the components of the PPCD 105, onboard unit 115, journey planning and pricing engine 140, and/or central database 145 of FIG. 1. FIG. 5 provides a schematic illustration of one embodiment of a computer system 500 that can perform the methods provided by various other embodiments, as described herein, and/or can function as the host computer system, a remote kiosk/terminal, a point-of-sale device, a mobile device, and/or a computer system. FIG. 5 is meant only to provide a generalized illustration of various components, any or all of which may be utilized as appropriate. FIG. 5, therefore, broadly illustrates how individual system elements may be implemented in a relatively separated or relatively more integrated manner.

The computer system 500 is shown comprising hardware elements that can be electrically coupled via a bus 505 (or may otherwise be in communication, as appropriate). The hardware elements may include a processing unit 510, including without limitation one or more general-purpose processors and/or one or more special-purpose processors (such as digital signal processing chips, graphics acceleration processors, and/or the like); one or more input devices 515, which can include without limitation a mouse, a keyboard, a touchscreen, a global positioning system (GPS) receiver, a motion sensor, a camera, and/or the like; and one or more output devices 520, which can include without limitation a display device, a speaker, a printer, and/or the like.

The computer system 500 may further include (and/or be in communication with) one or more non-transitory storage devices 525, which can comprise, without limitation, local and/or network accessible storage, and/or can include, without limitation, a disk drive, a drive array, an optical storage device, a solid-state storage device such as a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 500 might also include a communication interface 530, which can include without limitation a modem, a network card (wireless or wired), an infrared communication device, a wireless communication device and/or chipset (such as a Bluetooth™ device, an 502.11 device, a WiFi device, a WiMax device, an NFC device, cellular communication facilities, etc.), and/or similar communication interfaces. The communication interface 530 may permit data to be exchanged with a network (such as the network described below, to name one example), other computer systems, and/or any other devices described herein. In many embodiments, the computer system 500 will further comprise a non-transitory working memory 535, which can include a RAM or ROM device, as described above.

The computer system 500 also can comprise software elements, shown as being currently located within the working memory 535, including an operating system 540, device drivers, executable libraries, and/or other code, such as one or more application programs 545, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer-readable storage medium, such as the storage device(s) 525 described above. In some cases, the storage medium might be incorporated within a computer system, such as computer system 500. In other embodiments, the storage medium might be separate from a computer system (e.g., a removable medium, such as a compact disc), and/or provided in an installation package, such that the storage medium can be used to program, configure and/or adapt a general purpose computer with the instructions/code stored thereon. These instructions might take the form of executable code, which is executable by the computer system 500 and/or might take the form of source and/or installable code, which, upon compilation and/or installation on the computer system 500 (e.g., using any of a variety of generally available compilers, installation programs, compression/decompression utilities, etc.) then takes the form of executable code.

Substantial variations may be made in accordance with specific requirements. For example, customized hardware might also be used, and/or particular elements might be implemented in hardware, software (including portable software, such as applets, etc.), or both. Moreover, hardware and/or software components that provide certain functionality can comprise a dedicated system (having specialized components) or may be part of a more generic system. For example, an journey planning and pricing engine configured to provide some or all of the features described herein relating to the journey planning and/or pricing can comprise hardware and/or software that is specialized (e.g., an application-specific integrated circuit (ASIC), a software method, etc.) or generic (e.g., processing unit 510, applications 545, etc.) Further, connection to other computing devices such as network input/output devices may be employed.

Some embodiments may employ a computer system (such as the computer system 500) to perform methods in accordance with the disclosure. For example, some or all of the procedures of the described methods may be performed by the computer system 500 in response to processing unit 510 executing one or more sequences of one or more instructions (which might be incorporated into the operating system 540 and/or other code, such as an application program 545) contained in the working memory 535. Such instructions may be read into the working memory 535 from another computer-readable medium, such as one or more of the storage device(s) 525. Merely by way of example, execution of the sequences of instructions contained in the working memory 535 might cause the processing unit 510 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 500, various computer-readable media might be involved in providing instructions/code to processing unit 510 for execution and/or might be used to store and/or carry such instructions/code (e.g., as signals). In many implementations, a computer-readable medium is a physical and/or tangible storage medium. Such a medium may take many forms, including but not limited to, non-volatile media, volatile media, and transmission media. Non-volatile media include, for example, optical and/or magnetic disks, such as the storage device(s) 525. Volatile media include, without limitation, dynamic memory, such as the working memory 535. Transmission media include, without limitation, coaxial cables, copper wire and fiber optics, including the wires that comprise the bus 505, as well as the various components of the communication interface 530 (and/or the media by which the communication interface 530 provides communication with other devices). Hence, transmission media can also take the form of waves (including without limitation radio, acoustic and/or light waves, such as those generated during radio-wave and infrared data communications).

Common forms of physical and/or tangible computer-readable media include, for example, a magnetic medium, optical medium, or any other physical medium with patterns of holes, a RAM, a PROM, EPROM, a FLASH-EPROM, any other memory chip or cartridge, a carrier wave as described hereinafter, or any other medium from which a computer can read instructions and/or code.

The communication interface 530 (and/or components thereof) generally will receive the signals, and the bus 505 then might carry the signals (and/or the data, instructions, etc. carried by the signals) to the working memory 535, from which the processor(s) 505 retrieves and executes the instructions. The instructions received by the working memory 535 may optionally be stored on a non-transitory storage device 525 either before or after execution by the processing unit 510.

The methods, systems, and devices discussed above are examples. Some embodiments were described as processes depicted as flow diagrams or block diagrams. Although each may describe the operations as a sequential process, many of the operations can be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

While illustrative and presently preferred embodiments of the disclosed systems, methods, and devices have been described in detail herein, it is to be understood that the inventive concepts may be otherwise variously embodied and employed, and that the appended claims are intended to be construed to include such variations, except as limited by the prior art.

What is claimed is:

1. A computer-implemented method of providing trip planning using multiple modes of transportation, the method comprising:
obtaining, subsequent to a determination of a first route of travel, information regarding the first route of travel, wherein the first route of travel comprises a first set of travel instructions to a destination provided to a first user device;
determining, using the obtained information regarding the first route of travel, that travel along the first route of travel could be impacted;
determining, with a processing unit and based on the obtained information regarding the first route of travel, a second route of travel, wherein:
the second route of travel comprises a second set of travel instructions to the destination, different than the first set of travel instructions, and
the second route of travel involves multiple modes of transportation;
providing, via a communication interface, the second route of travel; and
receiving, via the communication interface, information for a payment associated with at least one of the multiple modes of transportation of the second route of travel.

2. The computer-implemented method of providing trip planning using multiple modes of transportation as recited in claim 1, wherein the information for the payment comprises a payment authorization, the method further comprising:
storing an account associated with a user; and
changing a value of the account to reflect the payment.

3. The computer-implemented method of providing trip planning using multiple modes of transportation as recited in claim 1, further comprising receiving, from the first user device, information regarding delivery of one or more products associated with the multiple modes of transportation.

4. The computer-implemented method of providing trip planning using multiple modes of transportation as recited in claim 3, further comprising providing, to a second user device, information for using at least one of the one or more products.

5. The computer-implemented method of providing trip planning using multiple modes of transportation as recited in claim 3, wherein the delivery of the one or more products includes at least one of:
displaying of a barcode,
printing of a paper ticket, or
changing a value of a user account.

6. The computer-implemented method of providing trip planning using multiple modes of transportation as recited in claim 1, wherein determining the second route of travel is further based on information regarding an environmental impact of the multiple modes of transportation.

7. The computer-implemented method of providing trip planning using multiple modes of transportation as recited in claim 1, wherein providing the second route of travel comprises providing the second route of travel to at least one of the first user device or a second user device.

8. The computer-implemented method of providing trip planning using multiple modes of transportation as recited in claim 1, wherein receiving the information for the payment comprises receiving the information for the payment from at least one of the first user device or a second user device.

9. A computing device for providing trip planning using multiple modes of transportation, the computing device comprising:
a memory;
a communication interface; and
a processing unit communicatively coupled with the memory and the communication interface, the processing unit configured to cause the computing device to:
obtain, subsequent to a determination of a first route of travel, information regarding the first route of travel, wherein the first route of travel comprises a first set of travel instructions to a destination provided to a first user device;
determine, using the obtained information regarding the first route of travel, that travel along the first route of travel could be impacted;
determine, with the processing unit and based on the obtained information regarding the first route of travel, a second route of travel, wherein:
the second route of travel comprises a second set of travel instructions to the destination, different than the first set of travel instructions, and
the second route of travel involves multiple modes of transportation;
provide, via the communication interface, the second route of travel; and
receive, via the communication interface, information for a payment associated with at least one of the multiple modes of transportation of the second route of travel.

10. The computing device for providing trip planning using multiple modes of transportation recited in claim 9, wherein the processing unit is further configured to cause the computing device to:
store an account associated with a user; and
change a value of the account to reflect the payment.

11. The computing device for providing trip planning using multiple modes of transportation recited in claim 9, wherein the processing unit is further configured to cause the computing device to receive, from the first user device, information regarding delivery of one or more products associated with the multiple modes of transportation.

12. The computing device for providing trip planning using multiple modes of transportation recited in claim 11, wherein the processing unit is configured to cause the computing device to determine the second route of travel based on information regarding an environmental impact of the multiple modes of transportation.

13. The computing device for providing trip planning using multiple modes of transportation recited in claim 9, wherein the processing unit is configured to cause the computing device to provide the second route of travel by providing the second route of travel to at least one of the first user device or a second user device.

14. The computing device for providing trip planning using multiple modes of transportation recited in claim 9, wherein the processing unit is further configured to cause the computing device to receive the information for the payment from at least one of the first user device or a second user device.

15. A non-transitory computer-readable medium having instructions embedded thereon for providing trip planning using multiple modes of transportation, the instructions comprising computer code for causing a computing device to:
receive information indicative of a first route of travel, the first route of travel comprising a first set of travel instructions to a destination;
receive, while the computing device is traveling along the first route of travel, information regarding a second route of travel, wherein:
the second route of travel comprises a second set of travel instructions to the destination, different than the first set of travel instructions, and
the second route of travel involves multiple modes of transportation;
receive user input regarding a payment associated with at least one of the multiple modes of transportation of the second route of travel; and
communicate, via a communication interface of the computing device and in response to receiving the user input, information regarding the payment associated with at least one of the multiple modes of transportation of the second route of travel.

16. The computer-readable medium as recited in claim 15, further comprising instructions for causing the computing device to receive, prior to receiving the user input, an indication that a user is in a safe environment to provide the user input.

17. The computer-readable medium as recited in claim 16, wherein the indication that a user is in a safe environment comprises an indication that the user has stopped moving.

18. The computer-readable medium as recited in claim 15, further comprising instructions for causing the computing device to receive an audio command as the user input.

19. The computer-readable medium as recited in claim 15, further comprising instructions for causing the computing device to receive user input regarding a selection of the second route of travel.

20. The computer-readable medium as recited in claim 19, further comprising instructions for causing the computing device to communicate, via the communication interface, information indicative of the selection of the second route of travel.
